(19) United States
(12) Patent Application Publication
(10) Pub. No.: US 2020/0390275 A1
(43) Pub. Date: Dec. 17, 2020

(54) COOKING APPARATUS

(71) Applicant: Shannon Colace, Brawley, CA (US)

(72) Inventor: Shannon Colace, Brawley, CA (US)

(21) Appl. No.: 16/835,142

(22) Filed: Mar. 30, 2020

Related U.S. Application Data
(60) Provisional application No. 62/825,255, filed on Mar. 28, 2019.

(51) Int. Cl. A47J 36/06; A47J 45/06; A47J 27/00; A47J 45/07

(52) U.S. Cl. CPC A47J 36/06; A47J 45/07; A47J 27/002; A47J 45/063

(57) ABSTRACT

An improved cooking apparatus includes a pot, and a multi-functional lid configured for useful integration with the pot; wherein the multi-functional lid serves multiple functions, including that of a conventional lid as well as the novel combinatory function of a bowl.

### CROSS-REFERENCE TO RELATED APPLICATIONS

This application claims benefit of priority with U.S. Provisional Application Ser. No. 62/825,255, filed Mar. 28, 2019; the entire contents of which are hereby incorporated by reference.

### BACKGROUND

Conventional cooking apparatus include pots, pans, and the like. These and a myriad of other cooking apparatus are widely known and available in the related art.

While many embodiments have been described and are widely known to one with skill in the art, there remains a continued need for improvements to conventional cooking equipment.

For example, in modern times there are an increasing number of condominiums and small townhomes becoming occupied, particularly in densely populated areas. This change is creating a problem with small living spaces, particularly kitchen space. In order to counteract the problem of reduced kitchen space, occupants are demanding multi-functional appliances and cookware that not only save time in the cooking process, require fewer components, and impose less cleanup, but also store away in compact spaces or eliminate the need for multiple similar items to accomplish the same cooking objectives.

In this regard, there are known to exist pots with lids that have integrated colander features; i.e. holes for draining liquid from pasta or other food. See, for example, U.S. Pat. No. 4,310,418 to Busbey; the entire contents of which are hereby incorporated by reference. The Busbey pot has significantly reduced storage space by eliminating the need for each of a cooking pot and a colander. Other benefits include less cleanup as there is only a pot and lid to wash as opposed to a pot, lid and colander. While the Busbey pot was certainly game changing at the time it was introduced to the market, there remains further need to combine features of various cookware componentry in a novel way for the purposes of reducing required storage space, more efficient cooking, and less cleanup.

Accordingly, it is an aim of the present invention to disclose a useful improvement in the art, whereby additional features, aspects, and advantages may be achieved by combining features of multiple conventional cookware items into a single integrated unit for reducing required storage space, enabling more efficient or faster cooking, and reducing cleanup impositions.

### SUMMARY

The disclosure concerns a cooking apparatus, namely, the combination of a pot, and a multi-functional lid configured for useful integration with the pot; wherein the multi-functional lid serves multiple functions, including: that of a conventional lid, as well as the novel combinatory function of a bowl. In some embodiments, the multi-functional lid can be configured for releasable attachment with the pot such that a user can rotate the entire apparatus without losing contents therein, and in certain embodiments, the pot is easily disengaged from the multi-functional lid for serving the contents. Certain illustrative features and advantages are disclosed for an improved cooking apparatus.

### BRIEF DESCRIPTION OF THE DRAWINGS

These and other features of the invention will become apparent to one having the ordinary level of skill in the art upon a thorough review of the following details and descriptions, particularly when reviewed in conjunction with the drawings, wherein:

FIG. 1A shows a cooking apparatus according to a first illustrated embodiment, wherein the apparatus non-inverted (cooking-side-up) and includes a multi-functional lid/bowl.

FIG. 1B shows the cooking apparatus according to the first illustrated embodiment, wherein the apparatus is inverted (serving-side-up).

FIG. 1C shows an exploded view of the cooking apparatus according to the first illustrated embodiment, wherein the apparatus includes a removeable handle configured to be inserted through apertures within the base feature and subsequently rotated to engage a channel. The lid-handle is removeable, leaving a base configured to support the multi-functional lid/bowl when utilized in the inverted (serving-side-up) position.

FIG. 1D illustrates the cooking apparatus configured for storage, wherein the multifunctional lid/bowl is configured to nest within the pot for achieving a reduced volume.

FIG. 1E shows an example of a pot including a spout for use with certain embodiments of the invention.

FIG. 1F shows an example of a pot including draining elements to replace a colander in accordance with other embodiments of the invention.

FIG. 2A shows a cross-section of the multifunctional lid/bowl in accordance with one embodiment, wherein the multifunctional lid/bowl includes a hinged-clamp for engaging the multifunctional lid/bowl with the pot.

FIG. 2B shows a cross-section of the multifunctional lid/bowl in accordance with one embodiment, wherein the multifunctional lid/bowl includes a friction-flange for engaging the multifunctional lid/bowl with the pot.

FIG. 2C shows a cross-section of the multifunctional lid/bowl in accordance with one embodiment, wherein the multifunctional lid/bowl includes a screw-thread for engaging the multifunctional lid/bowl with the pot.

FIG. 3 shows a cooking apparatus according to a second illustrated embodiment, wherein the apparatus non-inverted (cooking-side-up) and includes a multi-functional lid/bowl, two handles on opposite sides of the pot, a hinged clamp for removably engaging the multifunctional lid/bowl with the pot, and a base with integrated lid-handle which nests within the base.

### DETAILED DESCRIPTION OF EMBODIMENTS

For purposes of explanation and not limitation, details and descriptions of certain preferred embodiments are hereinafter provided such that one having ordinary skill in the art may be enabled to make and use the invention. These details and descriptions are representative only of certain preferred embodiments, however, and a myriad of other embodiments, which will not be expressly described, will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes of this disclosure, the term “pot” means a container, typically rounded or cylindrical and of ceramic ware or metal, used for storage or cooking;

“lid” means a removable or hinged cover for the top of a container;

“bowl” means a round, deep dish or basin used for holding food or liquid;

“colander” means a bowl-shaped kitchen utensil with holes in it used for draining liquid from food such as pasta or rice;

“multi-functional lid/bowl” means the lid as described herein, which is configured with a base and either a removeable lid-handle or a nesting lid-handle implemented with the base, such that the base, when inverted to arrange the base at the bottom-side relative to gravity, can function to support the lid as a bowl;

“pot” means a container, typically rounded or cylindrical and of ceramic ware or metal, used for storage or cooking;

“aperture” means an opening, hole, or gap;

“channel” means a groove or furrow; and

“vent-hole” means a hole for the escape of gas or air.

Any terms not explicitly defined herein are intended to be construed according to their usage within the context of this description, or according to their respective plain and ordinary meaning as would be appreciated by one having skill in the art.

Now, conventional cooking apparatus are known to include a pot and a lid. However, the lid is useful during cooking but is generally not used when cooking is finished. The lid simply goes to the sink for washing. In this disclosure, a cooking apparatus is described with a pot and a lid, wherein the lid can further function and be useful as a bowl, such as a serving bowl. In this regard, the lid becomes multi-functional and useful as both a bowl and a lid.

In order to achieve usefulness as a bowl, the multifunctional lid requires a base with a flat surface capable of supporting the multifunctional lid in the inverted orientation for use as a bowl. However, to retain its cooking function, the multifunctional lid must also provide a lid-handle.

Therefore, it is disclosed that the base can be provided with one or more apertures and a channel for receiving a removeable lid-handle, or the base can comprise a nested lid-handle that folds into or otherwise collapses into the base for providing the flat surface required to support the lid as a bowl. Alternative embodiments may include retractable features which prop the lid up as a bowl, or other similar mechanical variations, which are far too numerous to describe, and ultimately provide a multi-functional lid/bowl as describe herein.

Another useful aspect is provided with a multi-functional lid/bowl that is configured to nest within a corresponding pot of the cooking apparatus, such that the combination may be easily stored away when not in use.

In a general embodiment, a cooking apparatus is disclosed which includes a pot, and a multi-functional lid configured for useful integration with the pot; wherein the multi-functional lid serves multiple functions, including: that of a conventional lid, as well as the novel combinatory function of a bowl. In some embodiments, the multi-functional lid can be configured for releasable attachment with the pot such that a user can invert the entire apparatus without losing contents therein; and in certain embodiments, the pot is easily disengaged from the multi-functional lid for serving the contents.

Here, the pot includes a receptacle portion having a bottom, and an annular wall extending upwardly from the bottom forming a container volume therebetween. In addition, the pot includes an elongated handle or multiple loop-handles. Of particular distinction, the multi-functional lid includes a concave shape with an opening at a first end (“bowl-shape”), and a base disposed opposite the opening, wherein the multi-functional lid is configured to engage the receptacle portion of the pot and to function as a lid when in a first orientation, referred to as “non-inverted” (base positioned up and opening positioned down), and wherein the multi-functional lid is further configured to independently stand and to function as a bowl when in a second orientation opposite the first orientation, referred to as “inverted” with the base contacting a flat surface or a contour of the bowl engaging an annular rim of the pot if the bowl is placed in the pot (i.e. base positioned down and opening positioned up).

The base of the lid portion (which may also serve as a handle of the lid portion) is preferably fabricated from, or comprises, a relatively heat-resistant material, such as silicone.

An inner surface of the lid portion (also may be considered a bowl at times) may include a thermally conductive material, example steel, with or without a coating, such as TEFLON (polytetrafluoroethene), or may comprise glass or certain composite materials appreciated by one with skill in the art. An exterior surface of the lid portion may comprise an insulating or heat-resistant material for safe handling and other safety reasons.

The lid portion may comprise an insulated inner core for maintaining heated temperature of food contained therein when used as a bowl. In addition, the insulated inner core may further allow a heat-dampening of the outer surface for reducing likelihood of injury from burning.

In some embodiments, the lid portion may comprise a detachable or “removable” lid-handle. In this regard, the lid-handle may be detached from the multi-functional lid, thereby configuring a surface of the lid to be substantially flat and to function as a base or stand (i.e. a flat surface for becoming a base of the respective bowl). The detachable handle can comprise a pair of tabs disposed at each end of the handle, the tabs configured to correspond with entrance holes (“apertures”) and one or more channels in the base. In this regard, the tabs of the handle can be inserted into corresponding holes of the base, and the handle rotated in a first direction, for example, clockwise, for engaging the handle with the multi-functional lid portion. Similarly, the handle can be rotated in an opposite direction, for example, counter-clockwise, to align the tabs of the handle with the entrance holes, wherein the handle portion can be removed, leaving a flat base for preparing the multi-functional lid for use as a bowl upon inversion. Other means may be deployed for removably securing the handle to the multi-functional lid, for example, magnetic engagement and release mechanisms and other mechanical engagement and release mechanisms commonly deployed for removing detachable components.

In an alternative embodiment, the lid-handle can be hingedly or otherwise engaged with the base of the multi-functional lid/bowl such that the lid-handle can become nested with the base.

Turning now to the preferred embodiments, a cooking apparatus is shown and described.

### First Illustrated Embodiment

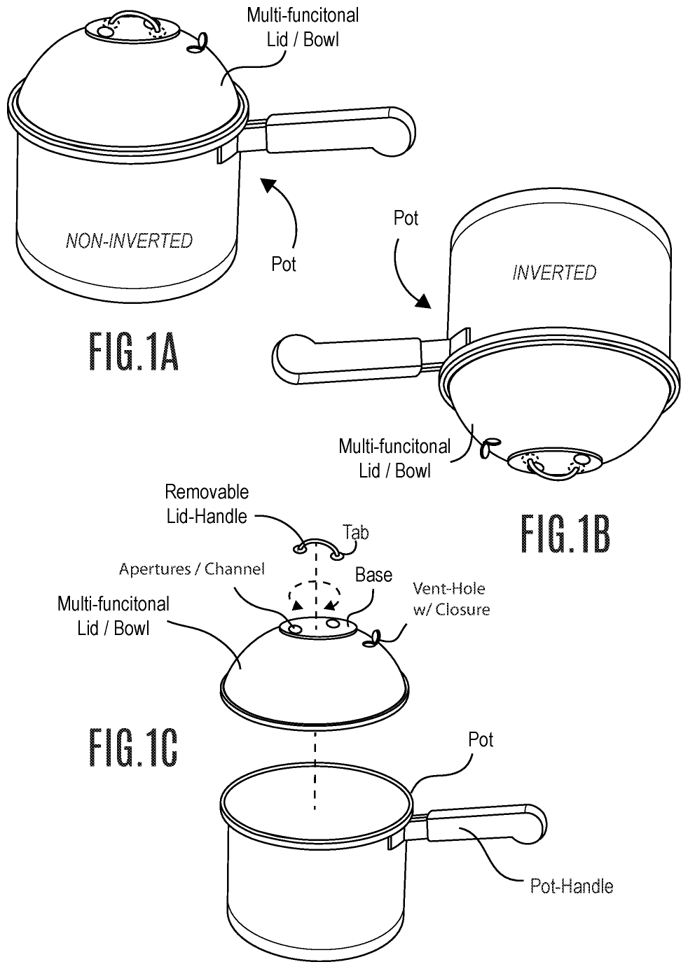

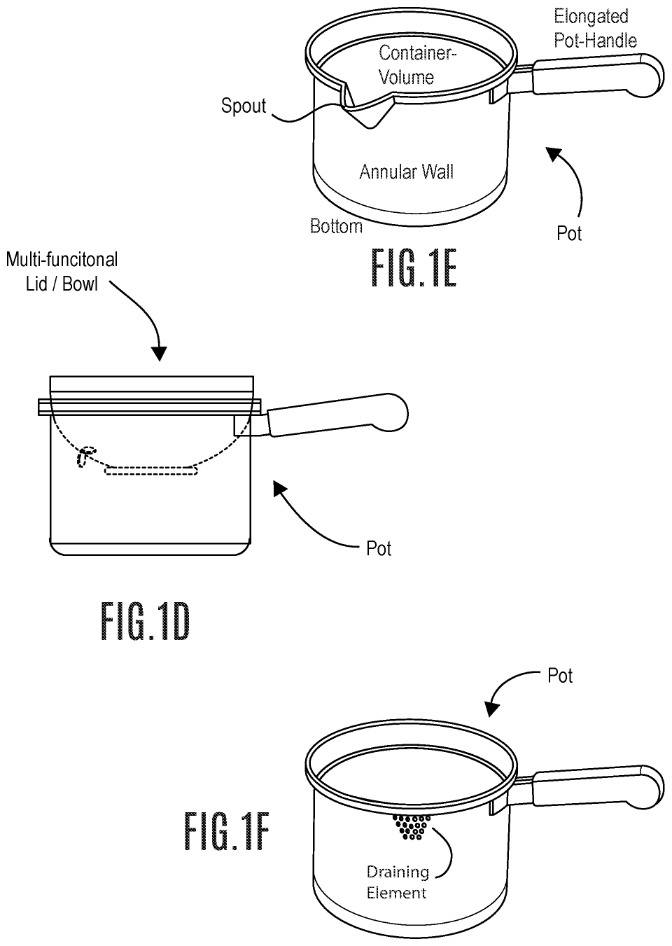

In a first illustrated embodiment as shown in FIG. 1(A-D), and with particular reference to FIG. 1A, a cooking apparatus includes a pot, and a multi-functional lid configured for useful integration with the pot; wherein the multi-functional lid serves multiple functions, including: that of a conventional lid, as well as the novel combinatory function of a bowl.

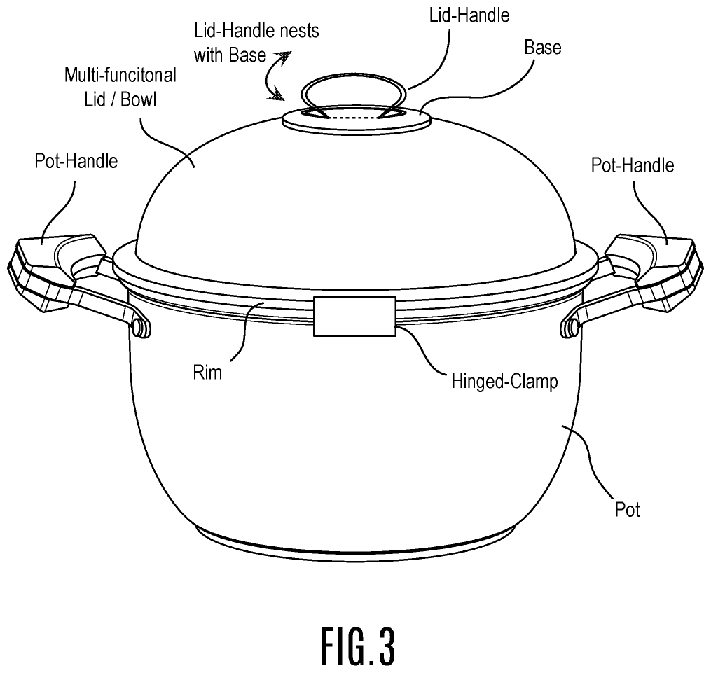

Here, the pot includes a receptacle portion having a bottom, and an annular wall extending upwardly from the bottom to an annular rim and forms a container volume therebetween. In addition, the receptacle portion may include an elongated handle (shown) or multiple loop-handles (see FIG. 3). Of particular distinction, the multi-functional lid includes a concave shape with an opening at a first end (“bowl-shape”), and a base, wherein the multi-functional lid is configured to engage the receptacle portion of the pot and to function as a lid when in a first non-inverted orientation (base positioned up and opening positioned down), and wherein the multi-functional lid is configured to independently stand with the base contacting a flat surface, or a contour of the bowl engaging an annular rim of the pot, and to function as a bowl when in a second inverted orientation, opposite the first orientation (i.e. base positioned down and opening positioned up).

The multi-function lid is shown including a vent-hole (though multiple vent-holes may be implemented) for venting steam from within the container volume during cooking. The vent-hole is shown further comprising an integrated snap-feature or otherwise referred to as a “closure” for closing the aperture (for example, where the user requires the lid to operate as a bowl and to retain liquid such as soup or the like). The snap-feature may be fabricated from a polymer composition, such as silicone, or from a metal material, such as steel, or other material known to be suitable for such purpose as would be appreciated by a skilled artisan. Where the lid portion includes multiple apertures, multiple snap-features may be similarly implemented.

Unique to the first illustrated embodiment is an attachment mechanism for attaching the multi-function lid to the pot, the attachment mechanism including a plurality of engagement elements each configured to extend from an annular rim of the pot and frictionally engage a corresponding lid portion for attachment therebetween. The engagement elements may be static (not moveable) or dynamically integrated (hinged or otherwise moveable) for contacting and engaging the lid portion according to one of a myriad of possible attachment techniques appreciated by one having skill in the art.

FIG. 1B shows the cooking apparatus according to the first illustrated embodiment, wherein the apparatus is inverted (serving-side-up). Once inverted, the contends of the pot are transferred to the multi-functional lid, and the pot can be removed by disengaging the attachment mechanism. Note, the lid-handle should be removed from, or folded into, the base prior to using the multi-functional lid/bowl as a bowl in the inverted orientation.

FIG. 1C shows an exploded view of the cooking apparatus according to the first illustrated embodiment, wherein the cooking apparatus includes a removeable handle having tabs configured to be inserted through apertures within the base feature and subsequently rotated to engage a channel. The lid-handle is removeable, leaving a base configured to support the multi-functional lid/bowl when utilized in the inverted (serving-side-up) position.

FIG. 1D illustrates the cooking apparatus configured for storage, wherein the multifunctional lid/bowl is configured to nest within the pot for achieving a reduced volume.

FIG. 1E shows an example of a pot including a spout for use with certain embodiments of the invention. Also described is the bottom, annular wall extending from the bottom, and container volume of the pot. An elongated handle is shown, although two pot handles, or other implementations of one or more handles may be utilized.

FIG. 1F shows an example of a pot including draining elements to replace a colander in accordance with other embodiments of the invention.

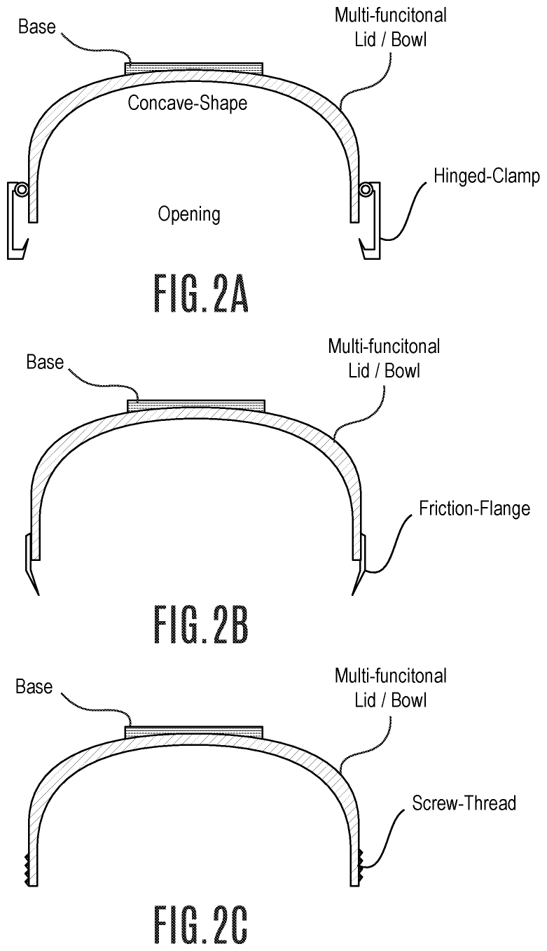

FIG. 2A shows a cross-section of the multifunctional lid/bowl in accordance with one embodiment, wherein the multifunctional lid/bowl includes a hinged-clamp for engaging the multifunctional lid/bowl with the pot. While two hinged-clamps are shown, it would be possible to provide a single lid-clamp and a flange at an opposite side, such that the flange can be first engaged and the lid-clamp being subsequently secured to attach the multi-functional lid/bowl with the pot. Other similar engagement means would be appreciated by one with skill in the art.

FIG. 2B shows a cross-section of the multifunctional lid/bowl in accordance with another embodiment, wherein the multifunctional lid/bowl includes a friction-flange for engaging the multifunctional lid/bowl with the pot. The friction-flange is made of a polymer material and works like a suction-cup to engage the lid to the pot.

FIG. 2C shows a cross-section of the multifunctional lid/bowl in accordance with yet another embodiment, wherein the multifunctional lid/bowl includes a screw-thread for engaging the multifunctional lid/bowl with the pot.

A myriad of possible embodiments may be implemented such that the multi-functional lid/bowl may be removably attached with the pot.

### Second Illustrated Embodiment

FIG. 3 shows a cooking apparatus according to a second illustrated embodiment, wherein the apparatus non-inverted (cooking-side-up) and includes a multi-functional lid/bowl, two handles on opposite sides of the pot, a hinged clamp for removably engaging the multifunctional lid/bowl with the pot, and a base with integrated lid-handle which nests within the base.

While various details, features, and combinations are described in the illustrated embodiments, one having skill in the art will appreciate a myriad of possible alternative combinations and arrangements of the features and details disclosed herein. As such, the descriptions are intended to be enabling only, and non-limiting. Instead, the spirit and scope of the invention is intended to be determined from the appended claims.

What is claimed is:

1. A cooking apparatus, comprising:
a pot, and
a multi-functional lid configured for useful integration with the pot;
wherein the multi-functional lid serves multiple functions, including:
that of a conventional lid as well as the novel combinatory function of a bowl.

2. The cooking apparatus of claim 1, wherein the multi-functional lid is configured for removeable attachment with the pot such that the apparatus can be flipped one hundred eighty degrees thereby transferring contents within the pot to the multi-functional lid, and wherein said multi-functional lid is configured to function as a bowl when inverted.

3. The cooking apparatus of claim 1, wherein the multi-functional lid comprises a lid-handle, and the lid-handle is detachable or configured to nest with a base.
